(19) United States
(12) Patent Application Publication
(10) Pub. No.: US 2025/0085141 A1
(43) Pub. Date: Mar. 13, 2025

(54) AUTOMATIC CALIBRATION OF ENCODERS

(71) Applicant: Avago Technologies International Sales Pte. Limited, Singapore (SG)

(72) Inventors: Childs Chang, Penang (MY); Kheng Hin Toh, Penang (MY); Heem Leong Ong, Penang (MY); Wei Keat Yew, Pulau Pinang (MY); Thomas Theil, Feldafing (DE)

(21) Appl. No.: 18/466,801

(22) Filed: Sep. 13, 2023

(51) Int. Cl. G01D 18/00

(52) U.S. Cl. CPC G01D 18/001

(57) ABSTRACT

Novel tools and techniques are provided for implementing an encoder capable of performing a self-calibration process, and more particularly methods, systems, and apparatuses are provided for implementing an encoder capable of performing a process to calibrate itself using a moving average algorithm. In various embodiments, the encoder includes an exciter and a sensor capable of detecting a position of the exciter and generating a signal based on the position of the exciter. The encoder can then perform one or more steps to calibrate itself using a moving average algorithm to account for variations in a rotation speed of the encoder.

### CROSS-REFERENCES TO RELATED APPLICATIONS

The present application is related to U.S. Application No.______(attorney docket number 1317.230050US01), entitled “Automatic Stabilization of Encoders”, filed______, and to U.S. Application No.______(attorney docket number 1317.230022US01), entitled “Automatic Calibration of Encoder based on Temperature”, filed______, which are commonly owned and incorporated by reference herein for all purposes.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general, to methods, systems, and apparatuses for implementing an encoder calibration, and more particularly to methods, systems, and apparatuses for implementing an encoder calibration by dividing a rotation of an exciter into two or more segments.

### BACKGROUND

Most types of encoders need to be calibrated before the encoders are used. The calibration of an encoder is typically only performed once in an encoder's lifetime (e.g., upon first setup of the encoder). In order to calibrate an encoder, a reference encoder is typically needed. The reference encoder is an extra encoder that has already been calibrated. The signals of the reference encoder are compared to the signals from the encoder. The encoder's signals are then corrected based on the comparison of the encoder's signal to the reference encoder's signal to determine the encoder's angular position. However, this calibration process with the reference encoder can typically only be performed once in factory because, once the encoder is calibrated, the reference encoder is removed and then the encoder is shipped from the factory to a customer.

Hence, there is a need for more robust and scalable solutions for implementing encoder calibration. Thus, methods, systems, and apparatuses for implementing encoder calibration using a moving average algorithm are provided.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. In some instances, a sub-label is associated with a reference numeral to denote one of multiple similar components. When reference is made to a reference numeral without specification to an existing sub-label, it is intended to refer to all such multiple similar components.

FIG. 1 is perspective view of a system having an encoder, in accordance with various embodiments;

FIG. 2A is a perspective view of an exciter of a magnetic encoder, in accordance with various embodiments;

FIG. 2B is a top view of an exciter of an optical encoder, in accordance with various embodiments;

FIGS. 3A-3E are flow diagrams of a method of calibrating an encoder, in accordance with various embodiments;

FIG. 4 is a graph illustrating the application of a moving average algorithm to a signal received from a sensor of the encoder, in accordance with various embodiments;

FIG. 5 is a graph illustrating the correction of a signal of the encoder using one or more correction values, in accordance with various embodiments;

FIG. 6 is a graph illustrating combining correction values for multiple rotation cycles of a signal of the encoder, in accordance with various embodiments;

FIG. 7 is a graph illustrating the determination of the correction of a signal of the encoder for one or more segments of a rotation cycle, in accordance with various embodiments; and

FIG. 8 is graph illustrating the division a rotation cycle into one or more segments, in accordance with various embodiments.

### DETAILED DESCRIPTION OF EMBODIMENTS

Various embodiments provide tools and techniques for implementing an encoder capable of calibrating itself. More particularly, methods, systems, and apparatuses are provided for implementing encoder calibration using a moving average algorithm.

In a first aspect, an encoder includes an exciter, a sensor configured to detect a position associated with the exciter and generate a signal based on the position, and a controller. The controller is further configured to run a process to calibrate the encoder. The process can include detecting a rotation of the exciter; receiving the signal from the sensor; and detecting a first position of the exciter and a second position of the exciter based on the signal for a first rotation cycle. After completing the first rotation cycle, the method continues by dividing the first rotation cycle into two or more first segments and determining for a first segment of the two or more first segments a first time to rotate the exciter through the first segment; and detecting a third position of the exciter and a fourth position of the exciter based on the signal for a second rotation cycle. After completing the second rotation cycle, the process to calibrate the encoder continues by dividing the second rotation cycle into two or more second segments and determining for a corresponding first segment of the two or more second segments a second time to rotate the exciter through the corresponding first segment. The corresponding first segment corresponds to the first segment of the first rotation cycle. Next, the process to calibrate the encoder comprises determining that the first time is within a first predetermined threshold of the second time; and based on a determination that the first time is within the first predetermined threshold of the second time, calibrating the signal of the sensor.

In some embodiments, the first position, the second position, the third position, and the fourth position are a same position.

In some instances, calibrating the signal of the sensor comprises detecting a start position and an end position of the exciter for at least one of the first segment or the corresponding first segment; detecting the exciter has reached a between position between the start position and the end position; determining a third time to rotate the exciter to the between position, wherein the third time is an actual time to rotate the exciter to the between position; calculating a fourth time to rotate the exciter to the between position between the start position and the end position based on at least one of the first time or the second time, wherein the fourth time is an expected time to rotate the exciter to the between position; and calculating a first value to correct the signal generated by the sensor for the between position based on a deviation between the third time and the fourth time.

In various embodiments, the first value is added to a look up table for the encoder to correct the signal of the encoder. In some cases, the first value is calculated for the between position of the first segment and the corresponding first segment, and the first value corresponding to the first segment and the corresponding first segment are combined and added to a look up table for the encoder to correct the signal of the encoder. In various instances, a moving average algorithm is used to determine at least one of the between position, the start position, or the end position of at least one of the first segment or the corresponding first segment.

In some instances, a moving average algorithm is used to determine the first position, the second position, the third position, the fourth position. In some cases, a rotation speed of the exciter is non-constant during the process to calibrate the encoder and the rotation speed of the exciter is not determined before the process to calibrate the encoder. In various embodiments, a ratio of a detection rate of the position of the exciter to a rotation speed of the exciter is at least 2500:1.

In various embodiments, the process further includes detecting a fifth position of the exciter and a sixth position of the exciter based on the signal for a third rotation cycle, wherein the third rotation cycle occurs before the second rotation cycle; after completing the third rotation cycle, dividing the third rotation cycle into two or more third segments and determining for a corresponding second segment of the two or more third segments a third time to rotate the exciter through the third segment, wherein the corresponding second segment corresponds to the first segment; determining the first time is not within the predetermined threshold of the third time; and based on a determination that the first time is not within the predetermined threshold of the third time, starting an other rotation cycle.

In some cases, the first rotation cycle is divided into two or more first segments based on a rotation speed of the exciter associated with each segment. In some cases, the first rotation cycle is divided into two or more first segments based on a number of harmonics of the signal, wherein a ratio of the number of segments to the number of harmonics of the signal is at least 2:1.

In another aspect, a method to calibrate an encoder can include detecting a rotation of an exciter of the encoder; detecting a signal from a sensor of the encoder, wherein the sensor detects a position associated with the exciter and generates the signal based on the position; detecting a first position of the exciter and a second position of the exciter based on the signal for a first rotation cycle; after completing the first rotation cycle, dividing the first rotation cycle into two or more first segments and determining for a first segment of the two or more first segments a first time to rotate the exciter through the first segment; detecting a third position of the exciter and a fourth position of the exciter based on the signal for a second rotation cycle; after completing the second rotation cycle, dividing the second rotation cycle into two or more second segments and determining for a corresponding first segment of the two or more second segments a second time to rotate the exciter through the second segment, wherein the corresponding first segment corresponds to the first segment; determining that the first time is within a first predetermined threshold of the second time; and based on a determination that the first time is within the first predetermined threshold of the second time, calibrating the signal of the sensor.

In some embodiments, the first position, the second position, the third position, and the fourth position are a same position.

In some instances, calibrating the signal of the sensor comprises detecting a start position and an end position of the exciter for at least one of the first segment or the corresponding first segment; detecting the exciter has reached a between position between the start position and the end position; determining a third time to rotate the exciter to the between position, wherein the third time is an actual time to rotate the exciter to the between position; calculating a fourth time to rotate the exciter to the between position between the start position and the end position based on at least one of the first time or the second time, wherein the fourth time is an expected time to rotate the exciter to the between position; and calculating a first value to correct the signal generated by the sensor for the between position based on a deviation between the third time and the fourth time.

In some cases, a rotation speed of the exciter is non-constant during the process to calibrate the encoder and the rotation speed of the exciter is not determined before the process to calibrate the encoder. In various embodiments, a ratio of a detection rate of the position of the exciter to a rotation speed of the exciter is at least 2500:1.

In yet another aspect, an encoder includes an exciter, a sensor configured to detect a position associated with the exciter and generate a signal based on the position, and a processor. The processor is further configured to detect a rotation of the exciter; receive the signal from the sensor; determine one or more variations in a rotation speed of the exciter exceed a first predetermined threshold; and based on a determination that the one or more variations exceed the first predetermined threshold, divide a rotation cycle of the encoder into two or more segments. The processor is further configured to determine a first position of the exciter of a first segment of the two or more segments based on the signal and determine a first time to rotate the exciter from the first position to a second position of the first segment. In some cases, the first position is different from the second position. Next, the processor is further configured to determine the exciter has reached a third position between the first position and the second position of the first segment based on the signal. The third position for the first segment is determined using a moving average algorithm. In some cases, the processor is further configured to determine a second time to rotate the exciter to the third position. The second time is an actual time to rotate the exciter to the third position. The processer is further configured to calculate a third time to rotate the exciter to the third position between the first position and the second position based on the first time. The third time is an expected time to rotate the exciter to the third position. Additionally, the processor is configured to calculate a first value to correct the signal generated by the sensor for the third position based on a deviation between the second time and the third time.

In some cases, dividing the rotation cycle into two or more segments is based on a rotation speed associated with each segment. In some embodiments, the processor is further configured to after calculating the first value for the first segment, calculate a second value to correct the signal for a fourth position in a second segment of the two or more segments; add the first value and the second value to a look-up table for the encoder; and use the look-up table to correct the signal received from the sensor for the third position of the first segment and the fourth position of the second segment.

In the following description, for the purposes of explanation, numerous details are set forth to provide a thorough understanding of the described embodiments. It will be apparent to one skilled in the art, however, that other embodiments may be practiced without some of these details. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

Similarly, when an element is referred to herein as being “connected” or “coupled” to another element, it is to be understood that the elements can be directly connected to the other element, or have intervening elements present between the elements. In contrast, when an element is referred to as being “directly connected” or “directly coupled” to another element, it should be understood that no intervening elements are present in the “direct” connection between the elements. However, the existence of a direct connection does not exclude other connections, in which intervening elements may be present.

Furthermore, the methods and processes described herein may be described in a particular order for ease of description. However, it should be understood that, unless the context dictates otherwise, intervening processes may take place before and/or after any portion of the described process, and further various procedures may be reordered, added, and/or omitted in accordance with various embodiments.

Unless otherwise indicated, all numbers used herein to express quantities, dimensions, and so forth should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components comprising one unit and elements and components that comprise more than one unit, unless specifically stated otherwise.

Additionally, it should be understood that spatial descriptions (e.g., “above,” “below,” “up,” “left,” “right,” “down,” “top,” “bottom,” “middle,” “vertical,” “horizontal,” etc.) used herein are for purposes of illustration only, and that practical implementations of the structures described herein can be spatially arranged in any orientation or manner. Additionally, it should be understood that numerical descriptions (e.g., “first,” “second,” “third,” etc.) used herein are for purposes of distinguishing one or more elements and are not intended to indicate a particular order unless stated otherwise.

In existing encoder calibration processes, a reference encoder is used to determine an encoder's angular position. When a reference encoder is used, both the encoder and the reference encoder must transmit information to a processor or controller to calibrate the encoder. The information from the encoder must then be compared to the reference encoder and the signal of the encoder must be corrected based on the information comparison between the reference encoder and the encoder. This existing calibration process is time-consuming and can only typically be performed once in an encoder's lifetime (e.g., at the factory). Once calibrated, the reference encoder is typically removed and the encoder is delivered to a user without the reference encoder.

The proposed encoder does not require a reference encoder. Additionally, the proposed encoder does not require that the motor or an exciter of the encoder rotate at a constant speed. Instead, the proposed encoder and proposed process to calibrate the encoder only requires the encoder. Further, to calibrate the proposed encoder, the motor and/or exciter of the encoder do not need to rotate at a constant speed. Instead, the encoder applies a moving average algorithm to a signal received from a sensor to account for variations in the speed of the encoder as the exciter and motor rotate. Additionally, a rotation of the exciter of the encoder can be divided into one or more segments in order to account for variations in the rotation speed of the exciter and motor shaft as the exciter and motor shaft rotate.

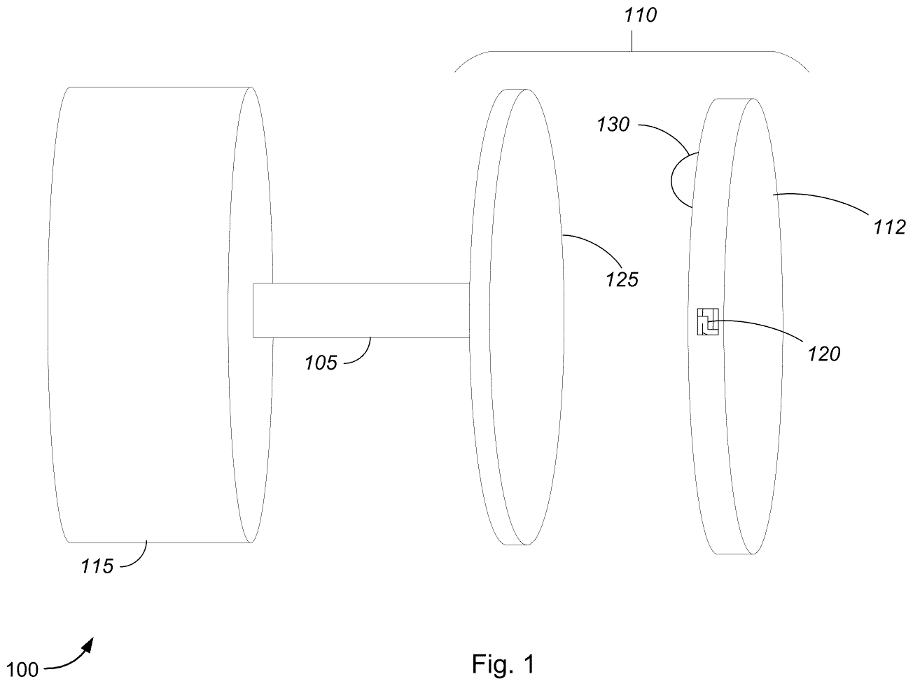

FIG. 1 is a perspective view of system 100 including a rotating body 105 and an encoder or encoder system 110, in accordance with various embodiments. The rotating body 105 includes, without limitation, a rotor disc, a shaft, and/or the like. In some cases, the rotating body 105 might be coupled to an optional motor 115 (e.g., electric motor, or the like). The motor 115 may be configured to cause the rotating body 105 to rotate.

In some embodiments, the encoder system 110 includes a housing 112, a processor or controller 120, an exciter 125, and a sensor 130. In some cases, the sensor 130 can be integrated within or on or included within or on the housing 112 or the controller 120. In various instances, the encoder 110 further includes a memory (not shown) which could be a non-transitory memory. In various embodiments, the controller 120 may be implemented in a system-on-chip (SoC) arrangement. The controller 120 might include a Microcontroller Unit (MCU), an Application Specific Integrated Chip (ASIC), or other forms of silicon based embedded chips.

The encoder system 110 can be a magnetic encoder, an optical encoder, or the like. The term “magnetic encoder” refers to a type of rotary encoder that uses one or more sensors to identify changes in magnetic fields from a rotating device (e.g., a magnetized wheel or ring, or the like) and generates signals indicating the angular position of the rotating device. The term “optical encoder” refers to a type of rotary encoder that uses one or more sensors to identify changes in light associated with the rotating device (e.g., a code wheel, code disc, or the like) and generates signals indicating an angular position of the rotating device. In some embodiments, the encoder system 110 is an absolute encoder which comprises a sensor that measures an absolute or true angular position of the rotating device of the encoder and generates a unique position value or signal based on the absolute or true angular position of the rotating device.

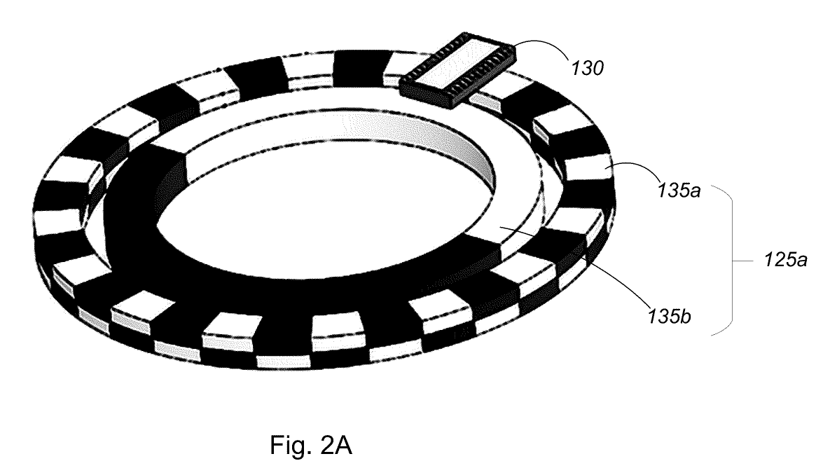

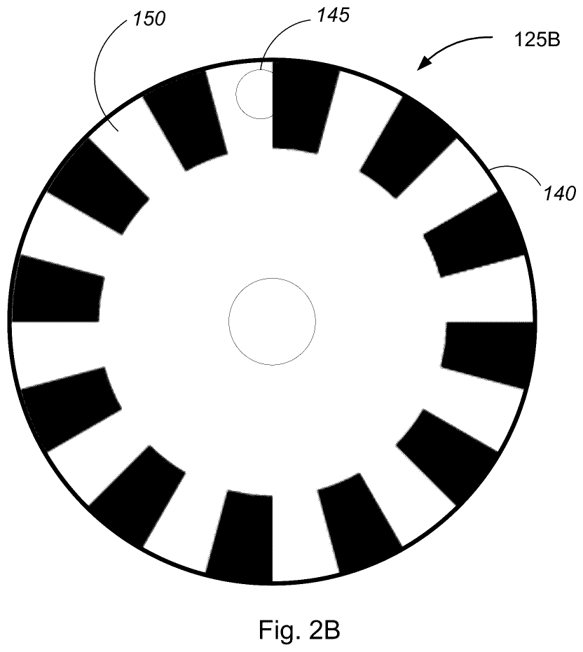

In various instances, the exciter 125 is a rotating device of the encoder system 110. In some cases, the exciter 125 is coupled to the rotating body 105. When the rotating body 105 rotates, the exciter 125 also rotates. The exciter 125 can be a different rotating device depending on whether the encoder is a magnetic encoder, an optical encoder, or the like. For example, as indicated above and as shown in FIG. 2A, the exciter 125a can be a magnetized wheel or ring or the like for a magnetic encoder. In the case of FIG. 2A, there are two magnetic wheels 135a and 135b comprising one or more magnets. The term “magnet” may refer to a material or object that produces a magnetic field (e.g., a force field that either pulls or repels certain materials, such as nickel or iron) and can include, without limitation, a permanent magnet, a temporary magnet, an electromagnet, or the like. Each magnet may have one or more pole pairs. A “pole pair” may refer to a pair of north and south poles, which are associated with the direction of the magnetic field.

Alternatively, as indicated above and as shown in FIG. 2B, the exciter 125b can be a code wheel or code disc 140 for an optical encoder. For an optical encoder, the encoder system 110 might further include light source 145 (e.g., a light emitting diode, a laser, or the like) and one or more openings 150 shown in FIG. 2B. The one or more openings 150 may be different shapes, sizes, or the like. In some cases, the one or more openings 150 might be one or more transparent pieces of material. The light source 145 might be configured to emit light toward the sensor 130 (not shown in FIG. 2B). As the exciter 125b rotates, the light from the light source 145 can be transmitted through the one or more openings 150 in exciter 125b toward the sensor 130.

The sensor 130 is positioned and configured to detect a position of the exciter 125 and identify changes in the angular position of the exciter 125. Based on the position of the exciter 125, the sensor 130 generates one or more signals representing or indicating the angular position of the exciter 125. In some embodiments, the exciter 125 rotates relative to the sensor 130 that is stationary.

In the case of a magnetic encoder, the sensor 130 detects a position of the exciter 125a by detecting a magnetic field associated with the exciter 125a as the exciter 125a rotates. The sensor 130 can include a Hall effect sensor or other type of magnetoresistive or magnetosensitive sensor, such as an Anisotropic Magnetoresistive (AMR) sensor, a Giant Magnetoresistive (GMR) sensor, and Tunnelling Magnetoresistive (TMR) sensor, or the like. Different magnetic fields may be formed at different positions along the exciter 125a. These different magnetic fields may vary based on the size (e.g., width, length, etc.) of the pole pairs, the number of magnets used, or the like.

In the case of an optical encoder, the sensor 130 is configured to detect changes in light emitted from the light source 145 through the openings 150 as the exciter 125b rotates. The sensor 130 might be a photoelectric sensor, a photodetector sensor, or the like. Different patterns of light may be formed at different positions along the exciter 125b depending on the size (e.g., width, length, etc.) of the one or more openings 150, depending on an amount of light emitted through the one or more openings 150, or the like.

In the case of the magnetic encoder where the sensor 130 detects a magnetic field of the exciter 125a or the optical encoder where the sensor 130 detects a light emitted from a light source through the exciter 125b, the sensor 130 generates a signal or one or more signals based on the detected magnetic field or the detected light. Differences in the magnetic field of the exciter 125a or light emitted through the exciter 125b can be represented by different parts of the signal. The signal might include electrical signals configured in sinusoidal waveforms. In other words, the signal that is generated by sensor 130 can include at least a sine signal and a cosine signal.

The sensor 130 can then send those signals to the controller 120. Based on the signals generated by the sensor 130, the controller 120 can determine or detect the angular position of the exciter 125. In a non-limiting example, in order to determine or detect a first position of the exciter 125, the sensor 130 might detect a first magnetic field or a first pattern of emitted light and generate a signal based on the detected first magnetic signal or first pattern of emitted light. Next, the controller 120 might receive that signal and determine or detect a position associated with the exciter 125 based on the signal generated from the detection of the first magnetic field or the first pattern. Based on the position of the exciter 125, the controller 120 can further determine or detect the position of the rotating body 105 of the motor.

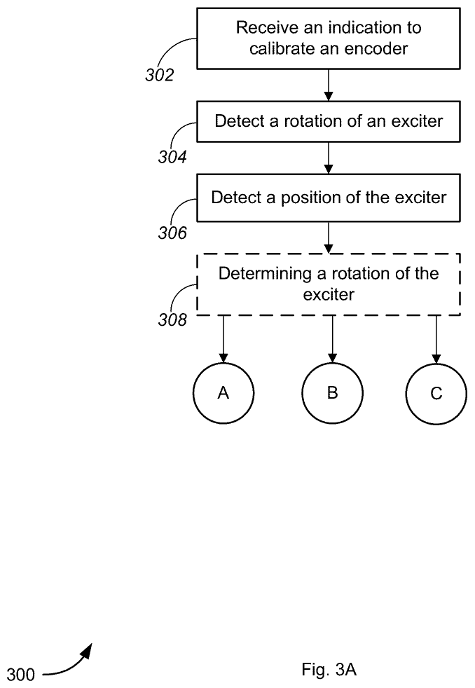

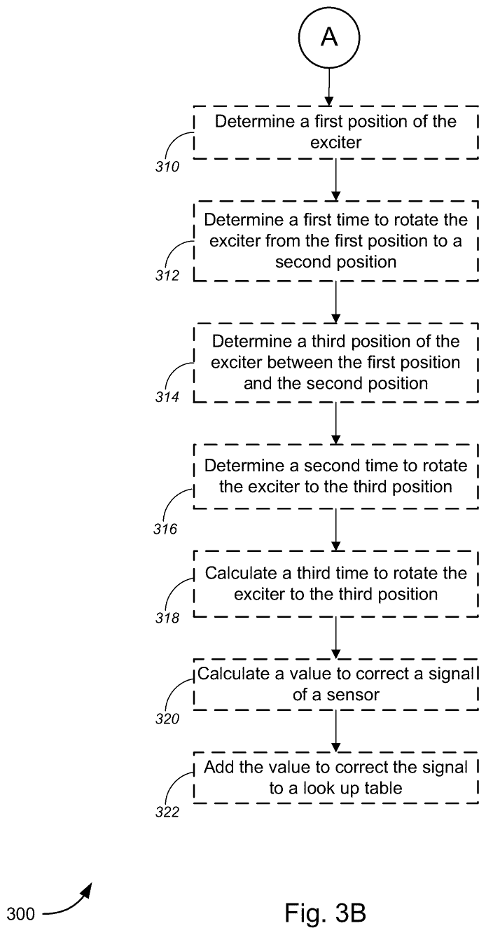

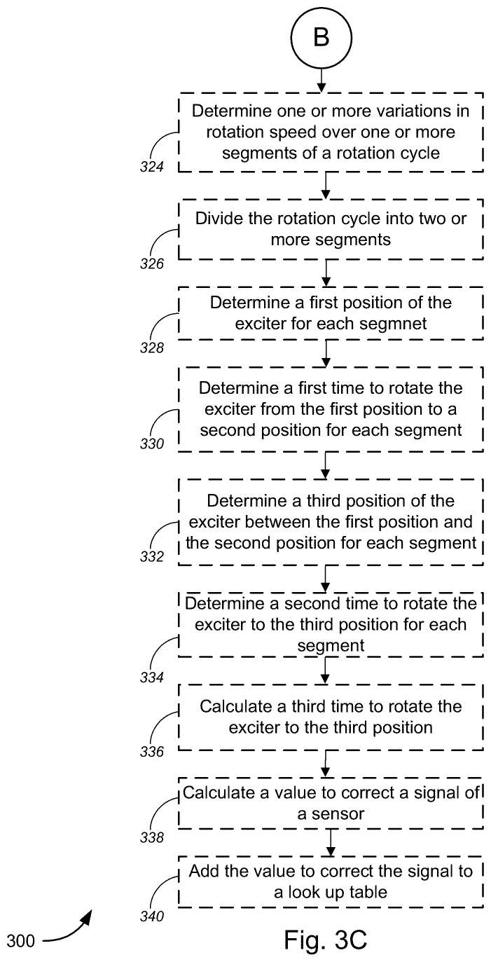

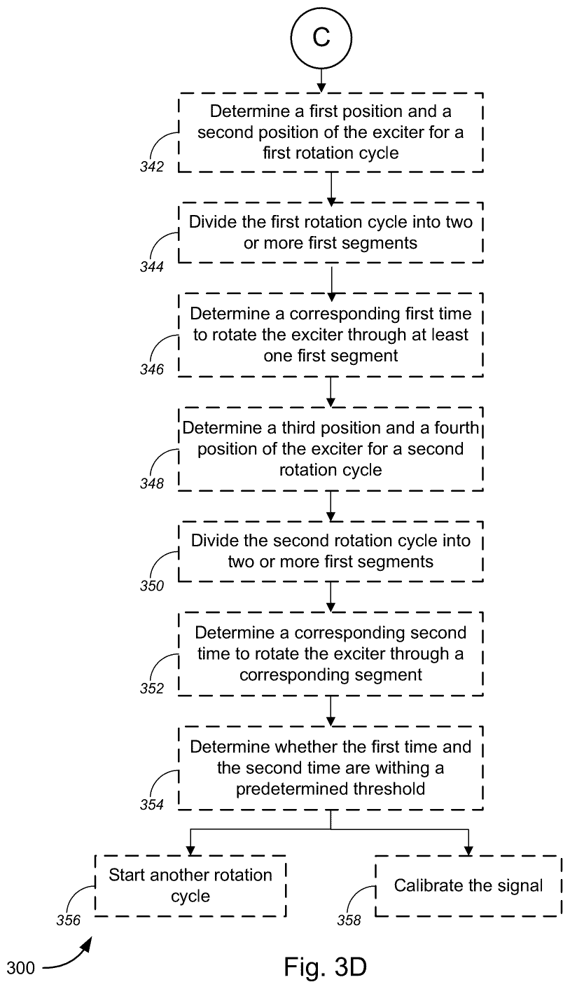

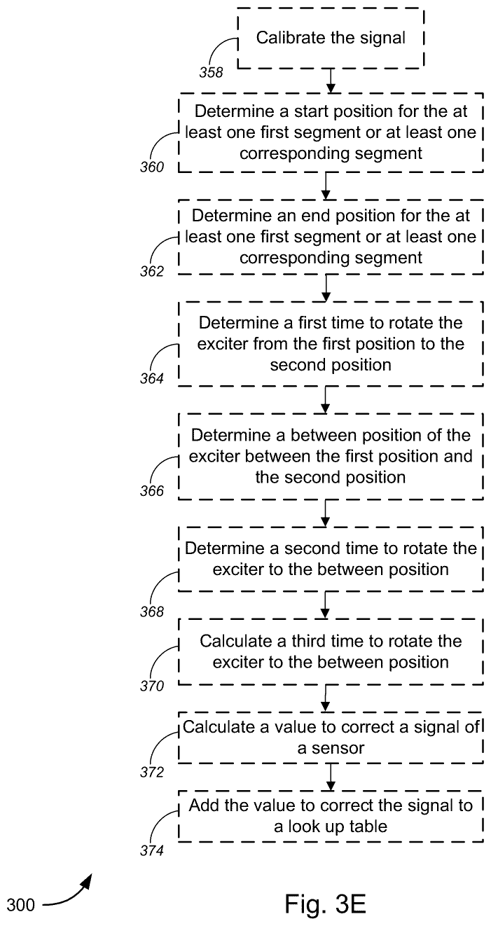

Turning to FIGS. 3A-3E (collectively, FIG. 3), FIG. 3A-3E are flow diagrams illustrating a process or method to calibrate an encoder, in accordance with various embodiments. This diagram merely provides an example, which should not unduly limit the scope of the claims. In some embodiments, the encoder system 110 shown in FIG. 1 is capable of performing an automatic calibration process 300 described in FIG. 3. However, the process is not limited to only being performed with the encoder of FIG. 1 and can be performed by other encoders or types of encoders. In some cases, a processor or controller (e.g., processor or controller 130) of the encoder is configured to execute the process 300. In some cases, multiple controllers are configured to execute one or more blocks or steps of the process 300. Alternatively, a single controller is configured to execute the blocks or steps of the process 300.

The process 300 can begin at optional block 302 by receiving an indication to calibrate an encoder (e.g., encoder system 110 or the like). The indication may be received from a user selecting a calibration button on the encoder. Alternatively, the indication may be based on a determination that the encoder system 110 has been turned on for a first time. Alternatively, the indication may occur after a predetermined amount of time (e.g., a week, a month, a year, or the like) since a first calibration of the encoder. In this case, the encoder can be recalibrated after a week, a month, a year, or the like.

Once the process 300 has been started, the process 300 may continue at block 304 by causing the exciter (e.g., exciter 125) of the encoder to rotate and/or detecting a rotation of the exciter. In order to rotate the exciter, the exciter might be coupled to a rotating body (e.g., rotating body 105) which may be coupled to a motor (e.g., motor 115). The motor can be turned on causing the rotating body and the exciter to rotate. In some cases, the exciter of encoder rotates at a speed that has not been predetermined by the encoder or motor. In some cases, the controller can cause the exciter to rotate. In other cases, the controller can detect that the exciter is rotating. In various instances, the exciter of the encoder starts rotating and then the controller can determine or detect the speed that the exciter is rotating by determining a first position of the exciter and a second position of the exciter and determining an amount of time to rotate the exciter from the first position to the second position.

Next, the process 300 might continue at block 306 by detecting or sampling a position of the exciter with a sensor (e.g., sensor 130) of the encoder as the exciter is rotating. The sensor can be configured to detect the position of the exciter continuously over one or more rotation cycles of the exciter. A rotation cycle is a rotation of the exciter from a first position to a second position. In some cases, the first position is the same as the second position. In the case, where the first position is the same as the second position, the rotation cycle of the exciter represents a full rotation (e.g., 360 degrees) of the exciter from the first position back to the first position. The sensor is configured to at least one of detect a magnetic field from one or more magnetic rings (e.g., magnetic rings 135) of the encoder or detect light emitted through one or more openings (e.g., openings 150) of the exciter from a light source (e.g., light source 145). The sensor converts the detected magnetic field or light to a signal. The controller of the encoder may then receive the signal and determine or detect a position of the encoder based on the signal received from the sensor.

In order to detect or determine the position of the exciter continuously over one or more rotation cycles of the exciter, a moving average algorithm can be applied to the signal. The moving average algorithm or filter is a calculation to analyze data points (e.g., a position of the exciter indicated by the signal generated by the sensor) by creating a series of averages of different selections of the full data set. Given a series of numbers and a fixed subset size, the first element of the moving average is obtained by taking the average of the initial fixed subset of the number series. Then the subset is modified by “shifting forward;” that is, excluding the first number of the series and including the next value in the subset. This moving average algorithm process can be applied to a first rotation cycle or an other rotation cycle of the exciter to filter out sudden angular positional deviations caused by variations (e.g., jerks, accelerations, braking, etc. affecting the rotation or the rotation speed of the exciter) in the rotation speed of the exciter. In other words, the moving average algorithm can be applied to signal generated by the sensor to smooth out the signal and account for sudden variations in a position of the exciter.

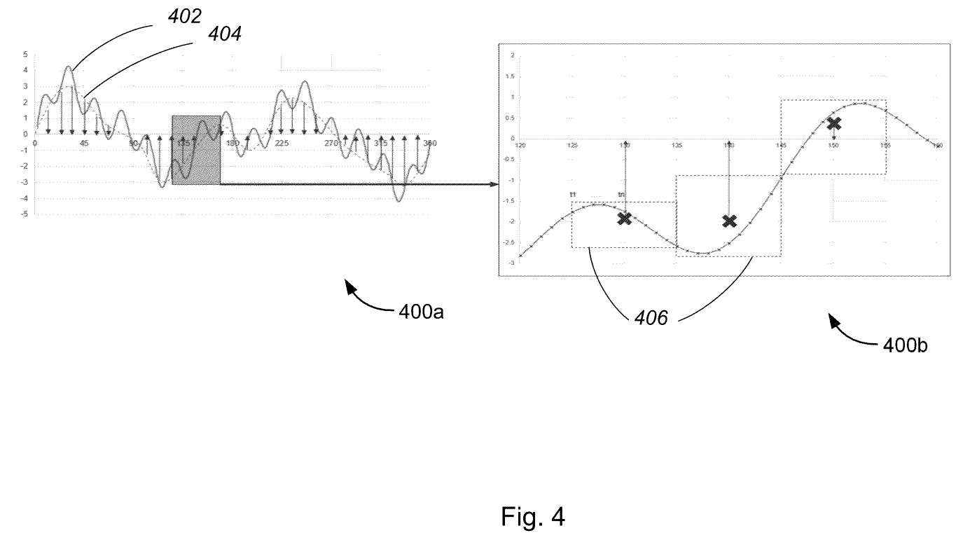

An example of applying a moving average algorithm to the signal received from the sensor is shown in graphs 400a and 400b of FIG. 4. As shown in graph 400a of FIG. 4, a position of the exciter may be irregular or deviate (as shown by the solid line 402) at different intervals due to variations in the rotation speed of the encoder. For example, the irregularities or deviations may be caused by a sudden motor irregular jerk or braking that could change the behavior of the signals generated by the exciter's angular rotation. By performing a moving average, as shown by the dotted line 404 in FIG. 4, the effect caused by such irregularities can be negated or smoothed. Graph 400b shows a zoomed in portion of the application of the moving average algorithm. Boxes 406 show areas of the graph where the position has been corrected based on the moving average algorithm to filter out sudden changes in the position of the exciter.

In order to more effectively apply a moving average algorithm to the signal generated by the sensor, the sampling frequency or detection frequency of the position of the exciter by the sensor can be higher than the speed of rotation of the exciter. For example, a ratio of the sampling frequency or detection frequency of the sensor versus the rotational speed of the exciter can be at least 2500 to 1. In other words, for each rotation cycle, the sensor may detect or sample the position of the exciter at least 2500 times.

In some cases, the controller can continuously monitor and determine the rotation speed of the exciter over one or more rotation cycles based on the detected position of the exciter. In various embodiments, the controller can monitor and determine the rotation speed of the exciter over one or more segments (e.g., pieces, divisions, sections, etc.) of the one or more rotation cycles.

At optional block 308, the process 300 continues by determining the rotation of the exciter based on the signal received from the sensor. Determining the rotation of the exciter includes continuously detecting a position of the exciter of the encoder for at least one rotation cycle.

In some embodiments, determining the rotation of the exciter further includes detecting a rotation speed of the exciter and/or one or more variations in a rotation speed of the exciter for at least one rotation cycle or one or more segments of a rotation cycle. One or more variations in the rotation speed of the exciter can be caused by jerks of the motor, rotational body, or exciter, braking of the motor, rotational body, or exciter, accelerations of the motor, rotational body, or exciter, defects in the machining or manufacturing of the motor, rotational body, encoder, irregular operation of the motor, rotational body, or exciter, or the like. When one or more variations occur in the rotation speed of the exciter, then the exciter is rotating at a non-constant speed through the rotation cycle.

The detection of one or more variations in the rotation speed of the exciter can be done by sampling (e.g., detecting) with the sensor the magnetic field or light to determine or detect two or more positions of the exciter as the exciter rotates. Additionally, the controller can track the amount of time it takes for the exciter to rotate to each position as the exciter rotates. The controller can determine, based on the position of the exciter and the amount of time it takes to rotate the exciter from a preceding position to a next position, a rotation speed to rotate the exciter between the preceding position and the next position of the exciter for a rotation cycle or a segment of the rotation cycle. The controller or processor can then track the rotation speed of the exciter as the exciter is rotating and detect one or more variations or irregularities in the rotation speed of the exciter between two or more positions of at least one rotation cycle or at least one segment of the rotation cycle.

Based on the number of variations detected, the controller can further determine whether the number of variations exceed a first predetermined threshold. If the number of variations in the rotation speed of the exciter exceed the first predetermined threshold for at least one rotation cycle, the controller can wait for one or more other rotation cycles to begin the calibration process where the number of variations is less than the first predetermined threshold. Alternatively, based on a determination that the number of variations exceeds the first predetermined threshold for at least one rotation cycle or a predetermined number of rotation cycles, the controller can pause or stop the calibration of the encoder and notify a user of the encoder of the irregular rotation speed of the exciter. The controller can pause or stop the calibration cycle because the rotation speed of the exciter is so irregular that the encoder cannot be calibrated. In some cases, the notification includes the reason why (e.g., one or more variations exceed the first predetermined threshold) the calibration has been paused or stopped.

In some cases, the encoder can further optionally determine whether the number of variations is less than the first predetermined threshold and less than a second predetermined threshold. If the number of variations is less than the first predetermined threshold and less than the second predetermined threshold, then the encoder can determine that there are minimal variations in the rotation speed of the exciter for a corresponding rotation cycle and assume that the rotation speed of the corresponding rotation cycle is relatively constant. In this scenario, the process can continue onto FIG. 3B indicated by circle A. Alternatively, if the number of variations is between the first predetermined threshold and the second predetermined threshold, then the process can continue onto FIG. 3C indicated by circle B or FIG. 3D indicated by circle C.

Based on a determination that the number of variations is less than the first predetermined threshold and less than a second predetermined threshold, the process 300 can continue the process to calibrate the encoder at optional block 310 and determine or detect a first position of the exciter based on the signal. In some cases, determining or detecting a first position of the exciter starts a first rotation cycle or an other rotation cycle of the calibration process. In some cases, the calibration process of the encoder can start at block 310 without determining the number of variations.

After determining or detecting the first position, the process 300 continues at optional block 312 by determining or detecting a second position and determining a first time to rotate the exciter from the first position to the second position for the first rotation cycle or an other rotation cycle. The first rotation cycle or an other rotation cycle represents a rotation from the first position to the second position. In some cases, the second position is the same as the first position and the first rotation cycle or an other rotation cycle represents a full rotation of the exciter from the first position back to the first position.

While the exciter is rotating for the first rotation cycle or an other rotation cycle, the process continues at optional block 314 by determining or detecting that the exciter has reached at least one third position between the first position and the second position based on the signal. A determination or a detection that the exciter has reached the at least one third position between the first position and the second position may be determined by applying a moving average algorithm or filter to the signal received from the sensor. In some cases, determining or detecting the first position and the second position of the exciter can also be done by applying a moving average algorithm or filter to the signal received from the sensor. This process to apply the moving average algorithm may be similar to the process described above.

Next, process 300 might continue on to optional block 316 and determine a second time to rotate the exciter to the at least one third position during the first rotation cycle or an other rotation cycle. In some cases, determining the second time to rotate the exciter to the at least one third position during the first rotation cycle includes determining the second time to rotate the exciter from a position preceding the third position to the at least one third position during the first rotation cycle or an other rotation cycle. In some cases, the preceding position is a position that is immediately preceding or directly before the third position. In some cases, the preceding position is the first position. The second time can be an actual time to rotate the exciter to the third position during the first rotation cycle or an other rotation cycle.

In some embodiments, the process 300 at optional block 318 includes calculating at least one third time to rotate the exciter to the at least one third position based on the first time. This calculation may be done based on the first time associated with the first rotation cycle or based on the first time associated with an other rotation cycle. This calculation represents an ideal or expected amount of time to rotate the exciter to the third position. This calculation can be performed based on an assumption of a constant speed of rotation of the exciter to rotate the exciter from the first position to the second position. In a non-limiting example, it might take 360 seconds to rotate the exciter 360 degrees from the first position to the second position (when the second position is the same as the first position). This means that in an ideal or expected scenario it takes the exciter one second to rotate one degree. Thus, if the third position is 180 degrees from the first position, it should ideally take the exciter 180 seconds to rotate to the third position from the first position. Alternatively, if the third position is located 180 degrees from the first position, an immediately preceding position (e.g., a position that is directly preceding the third position without any intervening positions) could be at 179 degrees. Thus, it should ideally take the exciter 1 second to rotate to the third position from the immediately preceding position.

At optional block 320, the process 300 might further include calculating a first value to correct the signal generated by the sensor for the at least one third position based on the second time and the third time. This calculation can be performed by comparing for the third position the ideal or expected rotation of exciter which is calculated in optional block 318 with the actual rotation of the exciter which is determined in optional blocks 314 and 316. By comparing the ideal or expected rotation with the actual rotation of the exciter a deviation of the actual rotation of the exciter from the ideal or expected rotation of the exciter for individual positions (e.g., the third position) can be determined. A correction value can be calculated to correct the deviation of the actual position over time from the calculated expected position over time. In a non-limiting example, the equation below can be used to calculate the correction value.

$$Correction\_Value = \frac{Second Time - Third Time}{First Time}$$

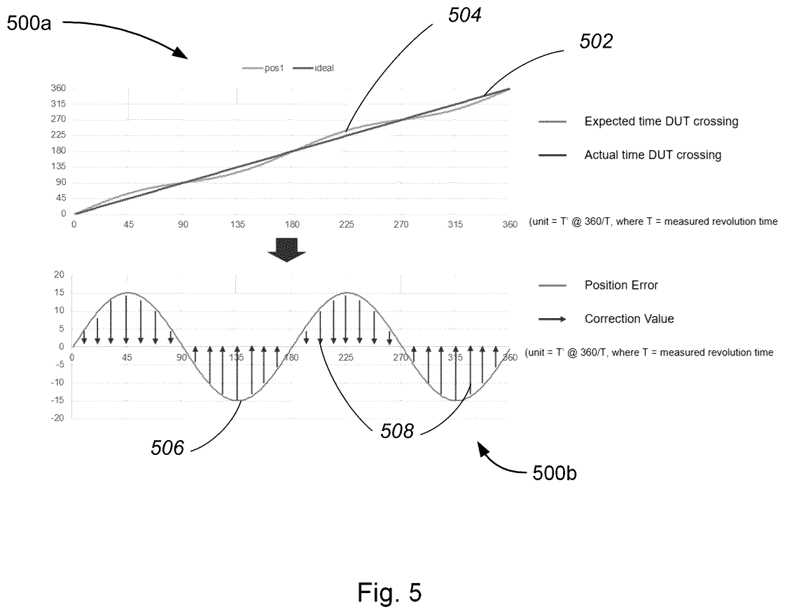

In some embodiments, if the actual time to reach the third position deviates from the expected time to reach the third position, the output signal of the encoder is corrected by the calculated deviation. The encoder can then directly output a corrected signal. The outputted corrected signal might be a second signal (e.g., a sinusoidal signal) that is generated (e.g., by the controller) based on the correction value and the signal of the sensor. This correction process is shown in graphs 500a and 500b of FIG. 5. For example, line 502 represents an expected time for each position while line 504 represents an actual time for each position. Additionally, line 506 represents the position error and lines 508 represent the correction value to correct the error in position. Thus, when a calculated or expected time is not reached for the third position, a corresponding correction value can be added to the measured or actual position, or when a calculated time is exceeded for the third position, a corresponding correction can be subtracted from the measured or actual position. If no deviation exists, the absolute position can be directly, i.e., without any corrective calculation, generated by the sensor of the encoder.

In some cases, the process at optional blocks 314-318 includes determining and calculating a corresponding amount of time it takes to rotate the exciter from the first position or a preceding position to each fourth position (including the at least one third position) in a plurality of fourth positions. In some cases, each fourth position represents at least 1 degree in 360 degrees. In other cases, each fourth position represents a pole of a magnet (e.g., a pole of the magnetic exciter 125a). When this is done, a corresponding value to correct the signal (block 320) can be calculated for each fourth position of the plurality of fourth positions. Additionally, a moving average algorithm can also be used to determine or detect each fourth position of the plurality of fourth positions.

At optional block 322, the process continues by adding the correction value to a look up table. The look up table can be generated by the controller of the encoder and stored in a memory of the encoder. The encoder may then use the look up table to correct the signal generated by the sensor based on the actual time to rotate the exciter to a particular position versus the ideal time to rotate the exciter to the particular position when the encoder is in use. In order to correct the signal generated by the sensor, the controller might generate a corrected signal based on one or more values in the look up table and the signal generated by the sensor.

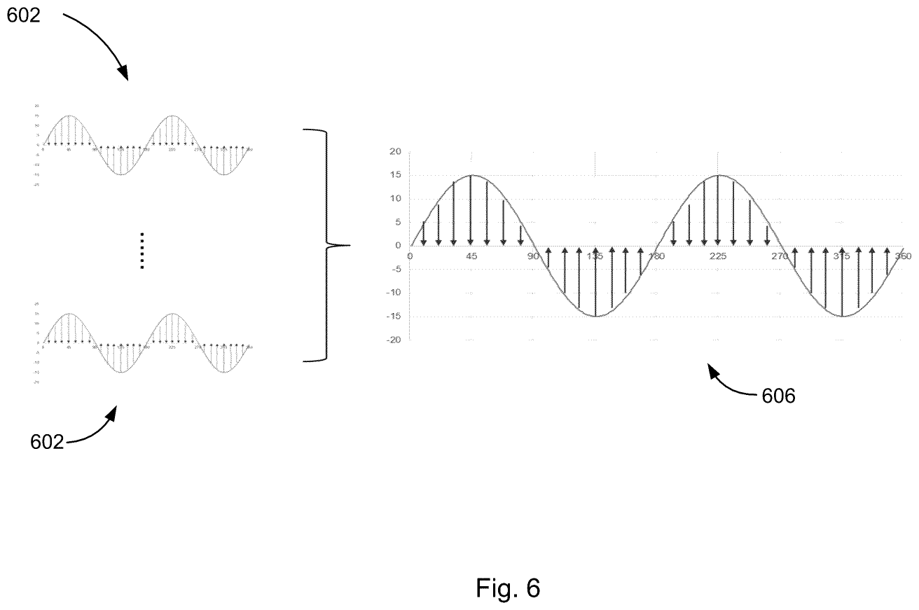

In some cases, optional blocks 310-320 can be repeated for multiple or a predetermined number of rotation cycles. The at least one third position can be determined for each rotation cycle of the multiple or predetermined number of rotation cycles. When these optional blocks 310-320 are repeated for multiple or the predetermined number of rotation cycles, the correction values corresponding to each rotation cycle can be combined (e.g., averaged) to generate a final look up table or graph (as shown in FIG. 6). For example, FIG. 6 shows a first rotation cycle 602, a second rotation cycle 604, and the combination (e.g., average) 606 of the first rotation cycle 602 and the second rotation cycle 604. The combination 606 of the first rotation cycle 602 and the second rotation cycle 604 can be added to the look up table.

In some cases, if the number of variations is between the first predetermined threshold and the second predetermined threshold, then the process can continue onto optional block 324 of FIG. 3C. For example, if the encoder is experiencing one or more variations in the rotation speed of the exciter, but the controller determines that the encoder can still be calibrated, the method continues on to optional block 324. Alternatively, in some cases, method 300 proceeds to optional block 324 of FIG. 3C even if the number of variations is not detected.

At optional block 324, the process 300 can determine whether the exciter is rotating at a non-constant speed or whether there are one or more variations or irregularities in the rotation speed of the exciter over one or more segments of a rotation cycle of the exciter. For example, whether the exciter exhibits a first rotation speed over a first segment versus a second rotation speed over a second segment of the rotation cycle or the like. This determination of one or more variations can be done by continuously determining the rotation speed of the exciter from one position to a next position over the rotation cycle. In some cases, the one or more variations in the rotation cycle are repeatable. In other words, the one or more variations repeat at a same or about a same position or location for each rotation cycle. Based on a determination that there are one or more variations in the rotation speed of the exciter over a rotation cycle of the exciter, the process at optional block 326 can divide the rotation cycle into two or more segments and perform the calibration cycle for each segment of the rotation cycle.

In a non-limiting example, each segment of the first rotation or other rotation might correspond to at least 1 degree in 360 degrees. In other cases, each segment represents a pole or multiple poles of a magnet (e.g., a pole of the magnetic exciter 125a). In some cases, the segments may be divided based on where the variations are occurring (e.g., the first segment might have a first rotation speed and a second segment may have a second rotation speed). Such cases may occur due to the usage of different types of motors (e.g., a three-phase motor may, depending on its construction have speed ripples or jitters of three harmonics when rotating within a single motor full turn or rotation). In this case, when the segments are divided based on where the variations are occurring, the segments may be different lengths. In some cases, a ratio of the number of segments to the number of phases of the signal is at least 2:1. In a non-limiting example, a signal can have one, two, or three harmonics or phases, thus the number of segments could be at least two, four, or six, respectively.

In some cases, the process 300 can continue and determine or detect at optional block 328, a first position of the exciter for each segment of a rotation cycle based on the signal. In some cases, the first position of each segment is a starting position for each segment. In some cases, the first position also represents the ending position of a preceding segment.

After determining or detecting the first position, the process 300 continues at optional block 330 by determining or detecting a second position and determining a first time to rotate the exciter from the first position to the second position for each segment. In some cases, the second position is an ending position of each segment. In some cases, the second position also represents the starting position of a next segment.

While the exciter is rotating, the process continues at optional block 332 by determining or detecting that the exciter has reached at least one corresponding third position between the first position and the second position for each segment based on the signal. A determination or a detection that the exciter has reached the at least one third position between the first position and the second position for each segment may be determined by applying a moving average algorithm or filter to the signal received from the sensor. In some cases, determining or detecting the first position and the second position of the exciter can also be done by applying a moving average algorithm or filter to the signal received from the sensor. This process may be similar to optional block 314 of FIG. 3B.

Next, process 300 might continue on to optional block 334 and determine a corresponding second time to rotate the exciter to the corresponding third position in each of the two or more segments. The corresponding second time can be an actual time to rotate the exciter to the corresponding third position in each of the two or more segments. This process may be similar to block 316 of FIG. 3B.

At optional block 336, the process might further include calculating at least one corresponding third time to rotate the exciter to the at least one corresponding third position in each segment. This calculation represents an ideal or expected amount of time to rotate the exciter to the corresponding third position in each segment. This process may be similar to block 318 of FIG. 3B.

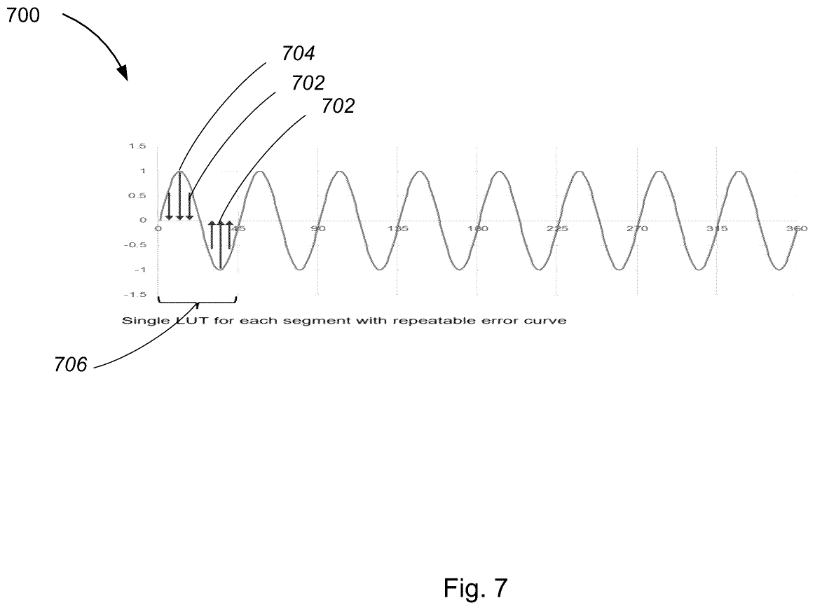

In some embodiments, the process 300 at optional block 338 might further include calculating for each segment a first value to correct the signal generated by the sensor for the corresponding third position in each of the two or more segments based on the corresponding second time and the corresponding third time. This process might be similar to block 320 of FIG. 3B. In a non-limiting example, graph 700 of FIG. 7 shows the calculation of one or more correction values 702 for one or more positions 704 of a first segment 706 of a rotation cycle.

Once a correction value for each segment or position in each segment of the rotation cycle is determined, the correction value for each segment can be added to a look up table at optional block 340. The encoder may then look up the correction value and correct the signal for each segment based on a determination that the exciter is rotating through a particular segment. In order to correct the signal generated by the sensor, the controller might generate a corrected signal based on one or more values associated with each segment in the look up table and the signal generated by the sensor.

In some cases, blocks 328-338 can be repeated for multiple or a predetermined number of rotation cycles. In other words, the at least one third position can be determined or detected for each corresponding third position for each segment of the multiple or predetermined number of rotation cycles. When these blocks 328-338 are repeated for multiple rotation cycles or the predetermined number of rotation cycles, the two or more correction values corresponding to each corresponding third position for each segment of each rotation cycle can be combined (e.g., averaged) to generate a final look up table (similar to the process described above).

In some cases, if the number of variations is between the first predetermined threshold and the second predetermined threshold, then the process can continue onto optional block 342 of FIG. 3D. For example, if the encoder is experiencing one or more variations in the rotation speed of the exciter, but the controller determines that the encoder can still be calibrated, the method continues on to optional block 342. Alternatively, in some cases, method 300 proceeds to optional block 342 of FIG. 3D even if the number of variations is not detected.

At optional block 342, the process 300 can determine or detect a first position of the exciter and a second position of the exciter based on the signal for a first rotation cycle. In some cases, the first position is a starting position of the first rotation cycle and the second position is an ending position of the first rotation cycle. In some cases, the first position is the same as the second position. In the case where the first position is the same as the second position, the rotation cycle of the exciter represents a full rotation of the exciter from the first position back to the first position.

After completing the first rotation cycle, the method 300 can divide the first rotation cycle into two or more first segments (optional block 344) and determine for at least one first segment of the two or more first segments a first time to rotate the exciter through the at least one first segment of the two or more first segments (optional block 346). In some cases, the method can determine a corresponding first time to rotate the exciter through each first segment of the two or more first segments. The first time represents an actual amount of time to rotate the exciter through the at least one first segment or a corresponding actual amount of time to rotate the exciter through each segment. In some cases, the actual amount of time to rotate the exciter through each first segment might vary from segment to segment.

In a non-limiting example, each segment of the first rotation cycle might correspond to at least 1 degree in 360 degrees. In other cases, each segment represents a pole or multiple poles of a magnet (e.g., a pole of the magnetic exciter 125a). In some cases, the segments may be divided based on where the variations are occurring (e.g., the first segment might have a first rotation speed and a second segment may have a second rotation speed). In some cases, each segment might have a different length. Such cases may occur due to the usage of different types of motors (e.g., a three-phase motor may, depending on its construction have speed ripples or jitters of three harmonics when rotating within a single motor full turn or rotation). Alternatively, in other cases, the segments can be divided based on a phase of the signal. In some cases, a ratio of the number of segments to the number of phases of the signal is at least 2:1. In a non-limiting example, a signal can have one, two, or three harmonics or phases, thus the number of segments could be at least two, four, or six, respectively.

At optional block 348, the process 300 can determine or detect a third position of the exciter and a fourth position of the exciter based on the signal for a second rotation cycle. In some cases, the third position is a starting position of the second rotation cycle and the third position is an ending position of the second rotation cycle. In some cases, the third position is the same as the fourth position. In some cases, the first position, the second position, the third position, and the fourth position are a same position. In the case where the first position, the second position, the third position, and the fourth position are a same position, the first rotation cycle and the second rotation cycle of the exciter represent two full rotations of the exciter.

After completing the second rotation cycle, the method 300 can divide the second rotation cycle into two or more second segments (optional block 350) and determine for at least one corresponding segment of the two or more second segments a second time to rotate the exciter through the at least one second segment of the two or more second segments (optional block 352). In some cases, the corresponding segment corresponds to the first segment of the first rotation cycle. In other words, the corresponding segment is the same as or about the same as the first segment of the first rotation cycle. In some cases, the method can determine a second time to rotate the exciter through each second segment of the two or more second segments. The second time represents an actual amount of time to rotate the exciter through the at least one second segment or a corresponding actual amount of time to rotate the exciter through each second segment. In some cases, the actual amount of time to rotate the exciter through each second segment might vary from segment to segment.

In a non-limiting example, each segment of the second rotation cycle might correspond to a segment of the first rotation cycle. In other words, a starting segment of the two or more first segments might correspond to a starting segment of the two or more second segments, while a next segment of the two or more first segments might correspond to a next segment of the two or more segments. This corresponding process might continue until a last segment of the two or more first segments corresponds to a last segment of the two or more second segment. In some cases, each second segment of the second rotation cycle is at least one of about the same length, has about the same positions, or rotates at about the same speed as the corresponding segment of the first rotation cycle.

Next, at optional block 354, the method 300 can continue by determining for at least one first segment of the two or more first segments whether the corresponding first time for the at least one first segment is within a first predetermined threshold of the corresponding second time of the corresponding first segment of the second rotation cycle. In other words, the method can determine whether the rotation speed through the at least one first segment is about the same as the rotation speed through the corresponding first segment of the second rotation cycle. This process can be performed for each segment of the one or more first segments. In other words, a first time for a starting segment of the two or more first segments might be compared to a second time for a starting segment of the two or more second segments, while a first time for a next segment of the two or more first segments might be compared to a second time for a next segment of the two or more segments. This comparison process might continue until a first time for a last segment of the two or more first segments is compared to a second time for a last segment of the two or more second segments. In some cases, a first time for each segment of the one or more first segments must be within the predetermined threshold of the corresponding second time of a corresponding segment of the second rotation cycle. Alternatively, in other cases, only at least one first segment must be within the first predetermined threshold of the corresponding second time of a corresponding segment of the second rotation cycle.

The predetermined threshold might be a percentage difference between the first time and the second time. The percentage difference might be less than 0.25%, 0.5%, 1%, 2%, 5%, or the like. In other words, if the first time to rotate the exciter through the first segment is 5 seconds while the second time to rotate the exciter through the corresponding first segment is 4.95 seconds, then the percentage difference is about 1% which is within the predetermined threshold.

If the corresponding first time for the at least one first segment is within the first predetermined threshold of the corresponding second time of the corresponding first segment of the second rotation cycle, the controller of the encoder can determine that the at least one first segment and the corresponding first segment are rotating in a similar or about a same manner. This is important because if there is a significant difference between the rotation of the at least one first segment and the corresponding first segment, then it is likely that the encoder cannot be calibrated because the exciter is not rotating consistently or smoothly.

Based on a determination that the corresponding first time for the at least one first segment is not within the first predetermined threshold of the corresponding second time of the corresponding first segment, the method can continue onto optional block 356 and start another rotation cycle. Starting another rotation cycle can include determining or detecting an additional starting position and ending position of the other rotation cycle, dividing the other rotation cycle into one or more other segments, and determining an other time to rotate the exciter through at least one corresponding segment of the two or more other segments. Next, the method can include determining for the at least one first segment of the two or more first segments or the at least one corresponding segment of the two or more second segments whether the corresponding first time for the at least one first segment or the corresponding second time for the at least one corresponding segment is within a first predetermined threshold of the corresponding other time of a corresponding segment of the third rotation cycle. This process can continue until two or more rotation cycles are obtained having corresponding segments within the predetermined threshold.

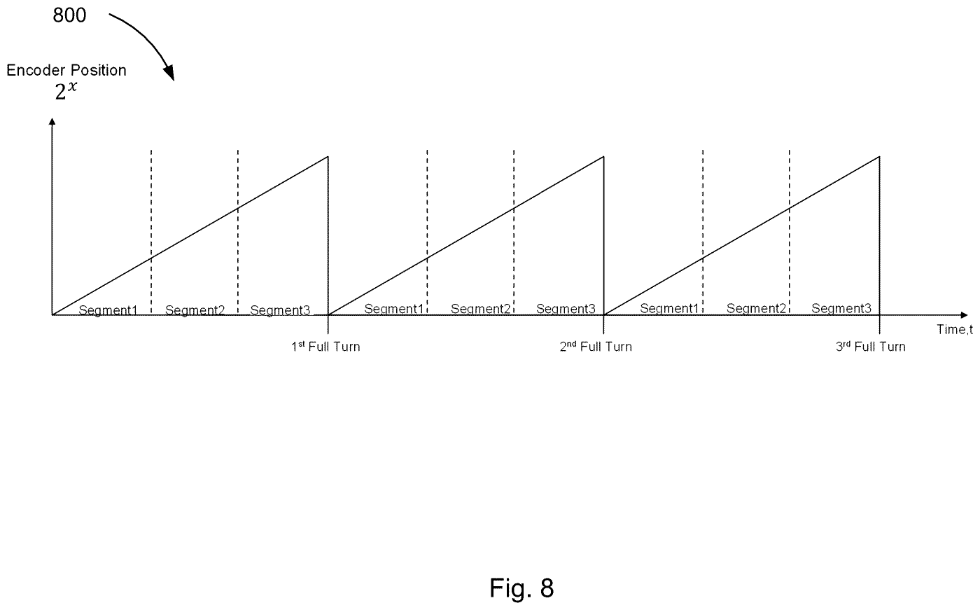

In a non-limiting example, the process of dividing the position of the exciter into one or more segments is shown in the graph 800 of FIG. 8. As shown in FIG. 8, a first rotation cycle, a second rotation cycle, and a third rotation cycle are shown. Each rotation cycle is divided into three segments. The first segment of the first rotation cycle corresponds to the first segments of the second and third rotation cycle, the second segment of the first rotation cycle corresponds to the second segments of the second and third rotation cycle, and the third segment of the first rotation cycle corresponds to the third segments of the second and third rotation cycle.

Based on a determination that the corresponding first time for the at least one first segment is within the first predetermined threshold of the corresponding second time of the corresponding segment, the method can continue onto optional block 358 and calibrate the at least first segment or the corresponding segment. This calibration process is described in FIG. 3E and is similar to blocks 328-340 of FIG. 3C.

In some cases, the process 300 can continue and determine or detect at optional block 360, a first position of the exciter for the at least one first segment and/or the at least one corresponding segment based on the signal. In some cases, the first position of is a starting position for the at least one first segment and/or the at least one corresponding segment. In some cases, the first position also represents the ending position of a preceding segment. In some cases, the first position for each segment of the two or more first segments and/or the two or more second segments can be determined.

After determining the first position, the process 300 continues at optional block 362 by determining or detecting a second position of the exciter for the at least one first segment and/or the at least one corresponding segment based on the signal. In some cases, the second position of is an ending position for the at least one first segment and/or the at least one corresponding segment. In some cases, the second position also represents the starting position of a next segment. In some cases, the second position for each segment of the two or more first segments and/or the two or more second segments can be determined.

In some cases, the process 300 continues at optional block 364 by determining the first time to rotate the exciter from the first position to the second position for the at least one first segment and/or the at least one corresponding segment. In some cases, the first time is determined for each segment of the two or more first segments and/or the two or more second segments. In some cases, this first time is the same time determined in blocks 346 and/or 352.

While the exciter is rotating, the process continues at optional block 366 by determining or detecting that the exciter has reached at least one corresponding third position between the first position and the second position for the at least one first segment and/or the at least one corresponding segment. In some cases, the third position is a between position (e.g., located between the first position and the second position). In some cases, the third position can be determined for each segment of the two or more first segments and/or the two or more second segments. This process may be similar to optional block 314 of FIG. 3B or optional block 332 of FIG. 3C.

Next, process 300 might continue on to optional block 368 and determine a corresponding second time to rotate the exciter to the corresponding third position for the at least one first segment and/or the at least one corresponding segment. The corresponding second time can be an actual time to rotate the exciter to the corresponding third position in each of the two or more segments. In some cases, the second time can be determined for each segment of the two or more first segments and/or the two or more second segments. This process may be similar to block 316 of FIG. 3B or block 334 of FIG. 3C.

At optional block 370, the process might further include calculating at least one corresponding third time to rotate the exciter to the at least one corresponding third position for the at least one first segment and/or the at least one corresponding segment. This calculation represents an ideal or expected amount of time to rotate the exciter to the corresponding third position in each segment. In some cases, the third time can be determined for each segment of the two or more first segments and/or the two or more second segments. This process may be similar to block 318 of FIG. 3B or block 338 of FIG. 3C.

In some embodiments, the process 300 at optional block 372 might further include calculating for the at least one first segment and/or the at least one corresponding segment a first value or a correction value to correct the signal generated by the sensor for the corresponding third position in the at least one first segment and/or the at least one corresponding segment based on the corresponding second time and the corresponding third time. This process can be performed or repeated for multiple positions within each segment. In some cases, this process might be similar to block 320 of FIG. 3B. In some cases, the first value can be determined for each segment of the two or more first segments and/or the two or more second segments and/or each position in each segment. This process may be similar to block 338 of FIG. 3C.

Once a correction value for the at least one first segment and/or the at least one corresponding segment is determined, the correction value for the at least one first segment and/or the at least one second segment can be added to a look up table at optional block 374. Alternatively, once a correction value for each segment or position in each segment of the rotation cycle is determined, the correction value for each segment can be added to a look up table. In some cases, a look up table can be generated for each segment of the one or more segments. In a non-limiting example, in FIG. 8, one or more first correction values for one or more positions in the first segment can be added to a first look up table, one or more second correction values for one or more positions in the second segment can be added to a second look up table, and one or more third correction values for one or more positions in the third segment can be added to a third look up table. The first, second, and third look up table can then be combined into one look up table having correction values to correct the signal of the encoder for an entire rotation cycle of the encoder. The encoder can then look up the correction value and correct the signal for each segment or position in each segment based on a determination that the exciter is rotating through a particular segment. This process may be similar to block 340 of FIG. 3C.

In some cases, blocks 360-374 can be repeated for multiple or a predetermined amount of rotation cycles. In other words, the at least one third position can be determined for each corresponding third position for each segment of the multiple or predetermined number of rotation cycles. When these blocks 328-338 are repeated for multiple rotation cycles or the predetermined number of rotation cycles, the two or more correction values corresponding to each corresponding third position for each segment of each rotation cycle can be combined (e.g., averaged) to generate a final look up table (similar to the process described in paragraph 0067). In a non-limiting example, a first value of a starting segment of a first rotation cycle can be combined with a first value of a starting segment of a second rotation cycle, a first value of a next segment of a first rotation cycle can be combined with a first value of a next segment of a second rotation cycle until a first value of a last segment of a first rotation cycle is combined with a first value of a last segment of a second rotation cycle.

The techniques and processes described above with respect to various embodiments may be used to calibrate the encoder system 110, and/or components thereof, as described herein.

While some features and aspects have been described with respect to the embodiments, one skilled in the art will recognize that numerous modifications are possible. For example, the methods and processes described herein may be implemented using hardware components, custom integrated circuits (ICs), programmable logic, and/or any combination thereof. Further, while various methods and processes described herein may be described with respect to particular structural and/or functional components for ease of description, methods provided by various embodiments are not limited to any particular structural and/or functional architecture but instead can be implemented in any suitable hardware configuration. Similarly, while some functionality is ascribed to one or more system components, unless the context dictates otherwise, this functionality can be distributed among various other system components in accordance with the several embodiments.

Referring generally again to FIGS. 1 and 3, for the purposes of the present disclosure, the term “controller,” “processor” or “processing element” may be broadly defined to encompass any device having one or more processing or logic elements (e.g., one or more micro-processor devices, one or more application specific integrated circuit (ASIC) devices, one or more field programmable gate arrays (FPGAs), or one or more digital signal processors (DSPs)). In this sense, the one or more processors may include any device configured to execute algorithms and/or instructions (e.g., program instructions stored in memory). Furthermore, the memory may include any storage medium known in the art suitable for storing program instructions executable by the associated processor. For example, the memory medium may include a non-transitory memory medium. By way of another example, the memory medium may include, but is not limited to, a read-only memory (ROM), a random-access memory (RAM), a magnetic or optical memory device (e.g., disk), a solid-state drive and the like. It is further noted that memory medium may be housed in a common controller housing with the processor. In embodiments, the memory medium may be located remotely with respect to the physical location of the processor.

In the present disclosure, the methods, operations, and/or functionality disclosed may be implemented as one or more steps in a switching hardware system or as sets of instructions or software readable by a device sets of instructions or software readable by a device. Further, it is understood that the specific order or hierarchy of steps in the methods, operations, and/or functionality disclosed are examples of exemplary approaches. Based upon design preferences, it is understood that the specific order or hierarchy of steps in the methods, operations, and/or functionality can be rearranged while remaining within the scope of the inventive concepts disclosed herein. The accompanying claims may present elements of the various steps in a sample order, and are not necessarily meant to be limited to the specific order or hierarchy presented.

What is claimed is:

1. An encoder comprising:
an exciter;
a sensor configured to detect a position associated with the exciter and generate a signal based on the position; and
a controller configured to run a process to calibrate the encoder, the process comprising:
detecting a rotation of the exciter;
receiving the signal from the sensor;
detecting a first position of the exciter and a second position of the exciter based on the signal for a first rotation cycle;
after completing the first rotation cycle, dividing the first rotation cycle into two or more first segments and determining for a first segment of the two or more first segments a first time to rotate the exciter through the first segment;
detecting a third position of the exciter and a fourth position of the exciter based on the signal for a second rotation cycle;
after completing the second rotation cycle, dividing the second rotation cycle into two or more second segments and determining for a corresponding first segment of the two or more second segments a second time to rotate the exciter through the corresponding first segment, wherein the corresponding first segment corresponds to the first segment of the first rotation cycle;
determining that the first time is within a first predetermined threshold of the second time; and
based on a determination that the first time is within the first predetermined threshold of the second time, calibrating the signal of the sensor.

2. The encoder of claim 1, wherein the first position, the second position, the third position, and the fourth position are a same position.

3. The encoder of claim 1, wherein calibrating the signal of the sensor comprises:
detecting a start position and an end position of the exciter for at least one of the first segment or the corresponding first segment;
detecting the exciter has reached a between position between the start position and the end position;
determining a third time to rotate the exciter to the between position, wherein the third time is an actual time to rotate the exciter to the between position;
calculating a fourth time to rotate the exciter to the between position between the start position and the end position based on at least one of the first time or the second time, wherein the fourth time is an expected time to rotate the exciter to the between position; and
calculating a first value to correct the signal generated by the sensor for the between position based on a deviation between the third time and the fourth time.

4. The encoder of claim 3, wherein the first value is added to a look up table for the encoder to correct the signal of the encoder.

5. The encoder of claim 3, wherein the first value is calculated for the between position of the first segment and the corresponding first segment, wherein the first value corresponding to the first segment and the corresponding first segment are combined and added to a look up table for the encoder to correct the signal of the encoder.

6. The encoder of claim 3, wherein a moving average algorithm is used to determine at least one of the between position, the start position, or the end position of at least one of the first segment or the corresponding first segment.

7. The encoder of claim 1, wherein a moving average algorithm is used to determine the first position, the second position, the third position, the fourth position.

8. The encoder of claim 1, wherein a rotation speed of the exciter is non-constant during the process to calibrate the encoder and the rotation speed of the exciter is not determined before the process to calibrate the encoder.

9. The encoder of claim 1, wherein a ratio of a detection rate of the position of the exciter to a rotation speed of the exciter is at least 2500:1.

10. The encoder of claim 1, wherein the process further comprises:
detecting a fifth position of the exciter and a sixth position of the exciter based on the signal for a third rotation cycle, wherein the third rotation cycle occurs before the second rotation cycle;
after completing the third rotation cycle, dividing the third rotation cycle into two or more third segments and determining for a corresponding second segment of the two or more third segments a third time to rotate the exciter through the third segment, wherein the corresponding second segment corresponds to the first segment;
determining the first time is not within the predetermined threshold of the third time;
based on a determination that the first time is not within the predetermined threshold of the third time, starting an other rotation cycle.

11. The encoder of claim 1, wherein the first rotation cycle is divided into two or more first segments based on a rotation speed of the exciter associated with each segment.

12. The encoder of claim 1, wherein the first rotation cycle is divided into two or more first segments based on a number of harmonics of the signal, wherein a ratio of the number of segments to the number of harmonics of the signal is at least 2:1.

13. A method for calibrating an encoder, the method comprising:
detecting a rotation of an exciter of the encoder;
detecting a signal from a sensor of the encoder, wherein the sensor detects a position associated with the exciter and generates the signal based on the position;
detecting a first position of the exciter and a second position of the exciter based on the signal for a first rotation cycle;
after completing the first rotation cycle, dividing the first rotation cycle into two or more first segments and determining for a first segment of the two or more first segments a first time to rotate the exciter through the first segment;
detecting a third position of the exciter and a fourth position of the exciter based on the signal for a second rotation cycle;
after completing the second rotation cycle, dividing the second rotation cycle into two or more second segments and determining for a corresponding first segment of the two or more second segments a second time to rotate the exciter through the second segment, wherein the corresponding first segment corresponds to the first segment;
determining that the first time is within a first predetermined threshold of the second time; and
based on a determination that the first time is within the first predetermined threshold of the second time, calibrating the signal of the sensor.

14. The method of claim 13, wherein the first position, the second position, the third position, and the fourth position are a same position.

15. The method of claim 13, wherein calibrating the signal of the sensor comprises:
detecting a start position and an end position of the exciter for at least one of the first segment or the corresponding first segment;
detecting the exciter has reached a between position between the start position and the end position;
determining a third time to rotate the exciter to the between position, wherein the third time is an actual time to rotate the exciter to the between position;
calculating a fourth time to rotate the exciter to the between position between the start position and the end position based on at least one of the first time or the second time, wherein the fourth time is an expected time to rotate the exciter to the between position; and
calculating a first value to correct the signal generated by the sensor for the between position based on a deviation between the third time and the fourth time.

16. The method of claim 13, wherein a rotation speed of the exciter is non-constant during the method to calibrate the encoder and wherein the rotation speed of the exciter is not determined before the method to calibrate the encoder.

17. The method of claim 13, wherein a ratio of a sampling rate of the signal to a rotation speed of the exciter is at least 2500:1.

18. An encoder comprising:
an exciter;
a sensor configured to detect a position associated with the exciter and generate a signal based on the position; and
a processor configured to:
detect a rotation of the exciter;
receive the signal from the sensor;
determine one or more variations in a rotation speed of the exciter exceed a first predetermined threshold;
based on a determination that the one or more variations exceed the first predetermined threshold, divide a rotation cycle of the exciter into two or more segments;
detect a first position of the exciter for a first segment of the two or more segments based on the signal;
determine a first time to rotate the exciter from the first position to a second position of the first segment;
detect the exciter has reached a third position between the first position and the second position of the first segment based on the signal, wherein the third position for the first segment is determined using a moving average algorithm;
determine a second time to rotate the exciter to the third position, wherein the second time is an actual time to rotate the exciter to the third position;
calculate a third time to rotate the exciter to the third position between the first position and the second position based on the first time, wherein the third time is an expected time to rotate the exciter to the third position; and
calculate a first value to correct the signal generated by the sensor for the third position based on a deviation between the second time and the third time.

19. The encoder of claim 18, wherein dividing the rotation cycle into two or more segments is based on a rotation speed associated with each segment.

20. The encoder of claim 18, wherein the processor is further configured to:
after calculating the first value for the first segment, calculate a second value to correct the signal for a fourth position in a second segment of the two or more segments;
add the first value and the second value to a look-up table for the encoder; and
use the look-up table to correct the signal received from the sensor for the third position of the first segment and the fourth position of the second segment.
